(19) United States
(12) Patent Application Publication
(10) Pub. No.: US 2020/0034622 A1
(43) Pub. Date: Jan. 30, 2020

(54) SYSTEMS AND METHODS FOR VISUAL INTERACTION WITH BUILDING MANAGEMENT SYSTEMS

(71) Applicant: Johnson Controls Technology Company, Auburn Hills, MI (US)

(72) Inventors: Rana Guha Thakurta, Pune (IN); Nicholas Gerard Busalacki, Brookfield, WI (US); Mrunal S. Bujone, Pune (IN); Eswarkumar Borra, Pune (IN); Sneha Santosh Pallewar, Pune (IN)

(73) Assignee: Johnson Controls Technology Company, Auburn Hills, MI (US)

(21) Appl. No.: 16/503,407

(22) Filed: Jul. 3, 2019

Related U.S. Application Data
(60) Provisional application No. 62/694,338, filed on Jul. 5, 2018.

(51) Int. Cl. G06K 9/00; G05B 15/02; G06T 11/00

(52) U.S. Cl. CPC G06K 9/00671; G06T 2200/24; G06T 11/00; G05B 15/02

(57) ABSTRACT

A system for displaying information to a user. The system includes a building management system (BMS) including at least one operating device. The system includes a mixed reality (MR) device. The MR device includes an optical projection system configured to display images and includes a controller including a processing circuit in communication with the optical projection system, the BMS, and a cloud database. The processing circuit is configured to receive a user input from a component of the MR device and provide a request for a device model and data describing the at least one operating device to the cloud database storing the device model and the data. The request is based on the user input. The processing circuit is configured to receive the device model and the data and display, via the optical projection system, a visualization of the device model and the data.

### CROSS-REFERENCE TO RELATED PATENT APPLICATION

This application claims the benefit of and priority to U.S. Provisional Patent Application No. 62/694,338 filed Jul. 5, 2018, the entire disclosure of which is incorporated by reference herein.

### BACKGROUND

The present disclosure relates generally to a building management system (BMS) and more particularly to user interactions with BMS data using a mixed and/or augmented reality device.

A building management system (BMS) is, in general, a system of devices configured to control, monitor, and manage equipment in or around a building or building area. A BMS can include a heating, ventilation, and air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include a variety of devices (e.g., HVAC devices, controllers, chillers, fans, sensors, etc.) configured to facilitate monitoring and controlling the building space.

Currently, many building management systems provide control of an entire facility, building, or other environment. For example, a building management system can be configured to monitor multiple buildings, each having HVAC systems, water system, lights, air quality, security, and/or any other aspect of the facility within the purview of the building management system. Some buildings may have several floors and each floor may be divided into a number of sections. Accordingly, building equipment and devices may be associated with a building, floor, and/or section.

### SUMMARY

One implementation of the present disclosure is a system for displaying information to a user, according to some embodiments. The system includes a building management system (BMS) including at least one operating device, according to some embodiments. The system includes a mixed reality (MR) device, according to some embodiments. The MR device includes an optical projection system configured to display images, according to some embodiments. The MR device includes a controller, according to some embodiments. The controller includes a processing circuit in communication with the optical projection system, the BMS, and a cloud database, according to some embodiments. The processing circuit is configured to receive a user input from a component of the MR device, according to some embodiments. The processing circuit is configured to provide a request for a device model and data describing the at least one operating device to the cloud database, according to some embodiments. The cloud database stores the device model and the data, according to some embodiments. The request is based on the user input, according to some embodiments. The processing circuit is configured to receive the device model and the data from the cloud database, according to some embodiments. The processing circuit is configured to display, via the optical projection system, a visualization of the device model and the data describing the at least one operating device, according to some embodiments.

In some embodiments, the data include historic data and real-time data of the at least one operating device.

In some embodiments, the processing circuit is configured to update the visualization based on a determination that new data describing the at least one operating device is gathered. The processing circuit is configured to update the visualization based on a detection of a user movement, according to some embodiments.

In some embodiments, the data describing the at least one operating device is real-time data and the BMS is configured to provide the real-time data describing the at least one operating device to the cloud database.

In some embodiments, the user input includes at least one of a voice command, a gesture, or a button press.

In some embodiments, the processing circuit is configured to determine if the MR device is within a predetermined proximity of the at least one operating device. The processing circuit is configured to, in response to a determination that the MR device is within the predetermined proximity, automatically provide the request for the device model and the data describing the at least one operating device to the cloud database, according to some embodiments.

In some embodiments, the system includes multiple MR devices. Each MR device of the multiple MR devices is configured to communicate with the BMS and the cloud database, according to some embodiments

Another implementation of the present disclosure is a system for displaying information to a user, according to some embodiments. The system includes a building management system (BMS) including at least one operating device, according to some embodiments. The system includes an augmented reality (AR) device, according to some embodiments. The AR device includes at least one camera configured to capture images relative to the AR device, according to some embodiments. The AR device includes a user interface configured to display the images, according to some embodiments. The AR device includes a controller, according to some embodiments. The controller includes a processing circuit in communication with the at least one camera, the user interface, a cloud database, and the BMS, according to some embodiments. The processing circuit is configured to receive a user input via the user interface, according to some embodiments. The processing circuit is configured to capture at least one image of the at least one operating device, according to some embodiments. The processing circuit is configured to provide a request for data describing the at least one operating device to the cloud database, according to some embodiments. The cloud database stores the data, according to some embodiments. The request is based on the user input, according to some embodiments. The processing circuit is configured to receive the data from the cloud database, according to some embodiments. The processing circuit is configured to display, via the user interface, a visualization of the data superimposed on the at least one image, according to some embodiments.

In some embodiments, the superimposed data provides a visual indication of a fault condition corresponding to the at least one operating device.

In some embodiments, the data describing the at least one operating device is real-time data and the BMS is configured to provide the real-time data describing the at least one operating device to the cloud database.

In some embodiments, the processing circuit is configured to update the visualization based on a determination that new data describing the at least one operating device is gathered. The processing circuit is configured to update the visualization based on a detection of a user movement, according to some embodiments.

In some embodiments, the processing circuit is configured to determine if the AR device is within a certain proximity of the at least one operating device. The processing circuit is configured to, in response to a determination that the AR device is within the certain proximity, automatically provide the request for the data describing the at least one operating device to the cloud database, according to some embodiments.

In some embodiments, the system includes multiple AR devices. Each AR device of the multiple AR devices is configured to communicate with the BMS and the cloud database, according to some embodiments.

Another implementation of the present disclosure is a method for displaying information to a user, according to some embodiments. The method includes receiving, by a mixed reality (MR) device of the user, a user input corresponding to a user request, according to some embodiments. The method includes providing, by the MR device, a request for a device model and data describing at least one operating device of a building management system (BMS) to a cloud database, according to some embodiments. The cloud database stores the device model and the data, according to some embodiments. The request is based on the user input, according to some embodiments. The method includes receiving, by the MR device, the device model and the data from the cloud database, according to some embodiments. The method includes displaying, by the MR device, a visualization of the device model and the data describing the at least one operating device, according to some embodiments.

In some embodiments, the data include historic data and real-time data of the at least one operating device.

In some embodiments, the method includes updating, by the MR device, the visualization based on a determination that new data describing the at least one operating device is gathered. The method includes updating, by the MR device, the visualization based on a detection of a user movement, according to some embodiments.

In some embodiments, the data describing the at least one operating device is real-time data and the BMS is configured to provide the real-time data describing the at least one operating device to the cloud database.

In some embodiments, the user input includes at least one of a voice command, a gesture, or a button press.

In some embodiments, the method includes determining, by the MR device, if a user device of the user is within a predetermined proximity of the at least one operating device. The method includes, in response to a determination that the user device of the user is within the predetermined proximity, automatically providing, by the MR device, the request for the device model and the data describing the at least one operating device to the cloud database, according to some embodiments.

In some embodiments, multiple MR devices are configured to communicate with the BMS and the cloud database.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of a waterside system which can be used to serve the building of FIG. 1, according to some embodiments.

FIG. 3 is a block diagram of an airside system which can be used to serve the building of FIG. 1, according to some embodiments.

FIG. 4 is a block diagram of a building management system (BMS) which can be used to monitor and control the building of FIG. 1, according to some embodiments.

FIG. 5 is a block diagram of a communication network including a mixed reality (MR) and/or augmented reality (AR) device, according to some embodiments.

FIG. 6 is a block diagram of the MR/AR device of FIG. 5, according to some embodiments.

FIG. 7 is a block diagram of a user interaction with an MR device, according to some embodiments.

FIG. 8 is a block diagram of another user interaction with the MR device of FIG. 7, according to some embodiments.

FIG. 9 is an example illustration of a user interacting with the MR device of FIG. 7, according to some embodiments.

FIG. 10 is an example illustration of a user's perspective while using the MR device of FIG. 7, according to some embodiments.

FIG. 11 is another example illustration of a user's perspective while using the MR device of FIG. 7, according to some embodiments.

FIG. 12 is another example illustration of a user's perspective while using the MR device of FIG. 7, according to some embodiments.

FIG. 13 is another example illustration of a user's perspective while using the MR device of FIG. 7, according to some embodiments.

FIG. 14 is an example illustration of users interacting with an AR device, according to some embodiments.

FIG. 15 is an example illustration of a user's perspective while using the AR device of FIG. 14, according to some embodiments.

FIG. 16 is an example illustration of a user interacting with the AR device of FIG. 14, according to some embodiments.

FIG. 17 is block diagram of a communication network including an MR/AR device, according to some embodiments.

FIG. 18 is a flowchart of a method for using an MR/AR device, according to some embodiments.

### DETAILED DESCRIPTION

### Overview

Interacting with devices and products is often a key component when training employees, troubleshooting, and demonstrating features to customers. Conventional training programs involve transporting employees to various facilities to work directly with existing equipment. Similarly, when operational issues arise, engineers/technicians either work remotely to instruct on-site employees, or must travel to the site to perform troubleshooting. With larger equipment, demonstrating functionality and features to potential customers is often not possible, or difficult to achieve.

Device connectivity within building systems permits for extensive data collection and analysis. In some situations, data from a building management system (BMS) is maintained on remote servers and/or cloud storage. As a result, data can be accessed from multiple places, regardless of where the devices are physically located.

The present disclosure includes systems and methods for viewing and interacting with building equipment, regardless of location ins some embodiments. In some embodiments, a mixed reality (MR) device may access cloud data relating to a BMS. Further, the mixed reality device may simulate current and/or past BMS equipment operation. In some embodiments, the mixed reality device may be configured to cover a user's eyes. The mixed reality device may then be configured to project a hologram of the BMS equipment. In some embodiments, a user may interact with the projected hologram (e.g., a user may provide gestures and/or vocal inputs to affect a change in the projected hologram). In some embodiments, the mixed reality device is a head worn display with a combiner for viewing augmented reality graphics superimposed over a real world scene.

In some embodiments, an augmented reality (AR) device may access cloud data relating to a BMS. Further, the augmented reality device may simulate current and/or past BMS equipment operation. In some embodiments, the augmented reality device may be handheld (e.g., a tablet, laptop, smartphone, etc.). The augmented reality device may then be configured to display, via an interface, data corresponding to BMS equipment. In some embodiments, a user may interact with the display (e.g., a user may provide touch and/or vocal inputs to affect a change in the displayed image). In some embodiments, the augmented reality device may be configured to overlay cloud data onto a current image of the corresponding BMS equipment. As one non-limiting embodiment, a user may hold a tablet in front of a row of devices, and the displayed image may show the row of devices as well as an indication of which devices are in a fault state.

Augmented reality and mixed reality are related technologies. Generally, augmented reality may overlay virtual elements onto an image of the real world. In contrast, mixed reality systems may overlay virtual elements onto an image of the real world, but may also enable a user to directly interact with the virtual elements (e.g., interacting with a hologram). As used herein, the term “augmented reality” may be defined as a system or method where virtual elements are superimposed onto another image. Further, as used herein, the term “mixed reality” may be defined as a system or method where virtual elements appear projected to a user, allowing the user to interact with the virtual elements.

As described in greater detail below, data representing components of the BMS (e.g., building equipment, a building, etc.) can be stored on a cloud database hosted by a cloud provider. Further, the cloud database can store device models of the building equipment. The device models can be used by the MR device and/or the AR device to generate projections of related components. The cloud database case also store historic and/or real-time data describing the components. In this way, the MR device and/or the AR device can request the data from the cloud database in order to project the data to a user. By hosting said information (e.g., the device models, the data, etc.) on the cloud database, multiple MR and AR devices can access the information so long as there is an active connection to the cloud database. In this way, users can interact with components of the BMS remotely and/or on-site. These and other features of the systems and methods are described in detail below.

### Building HVAC Systems and Building Management Systems

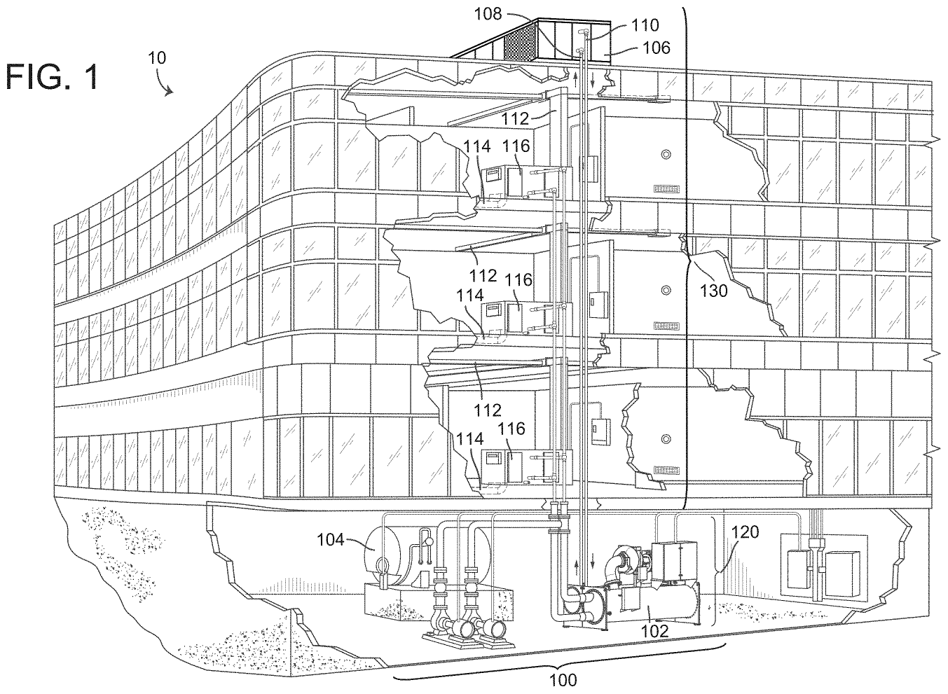

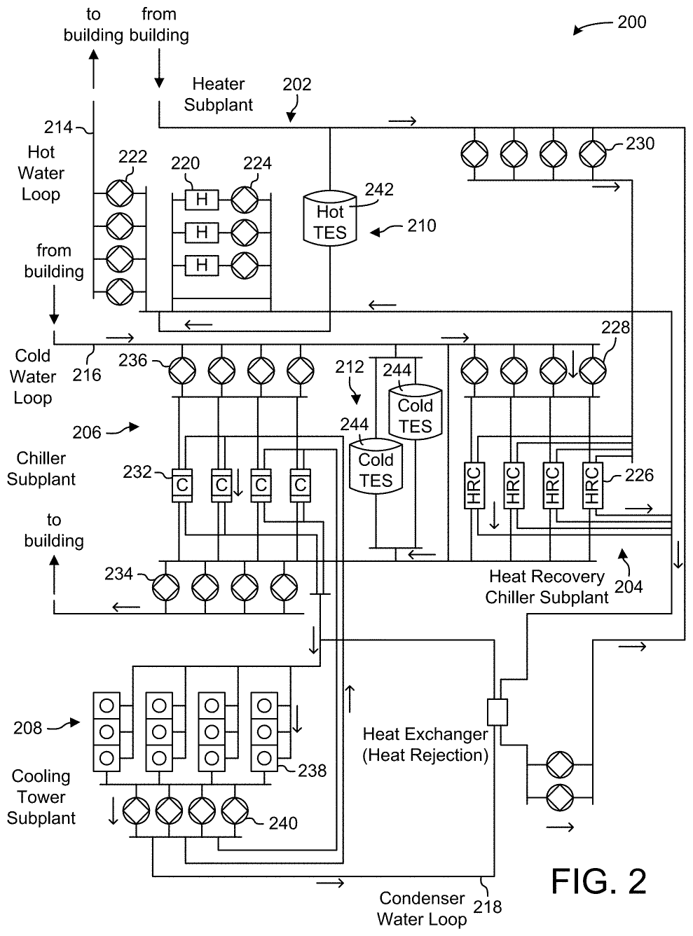

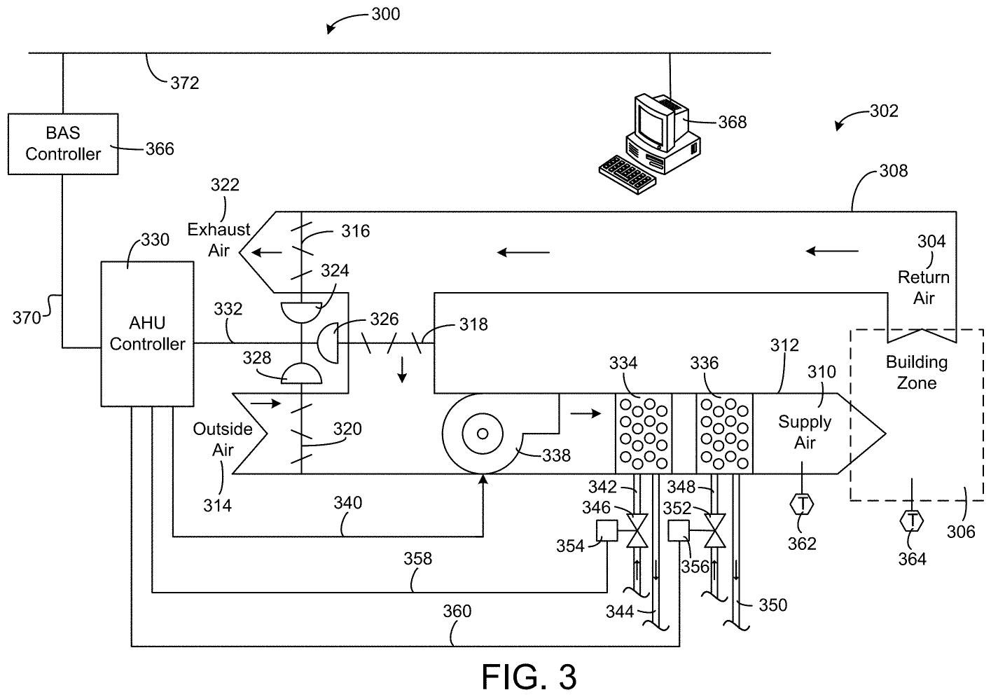

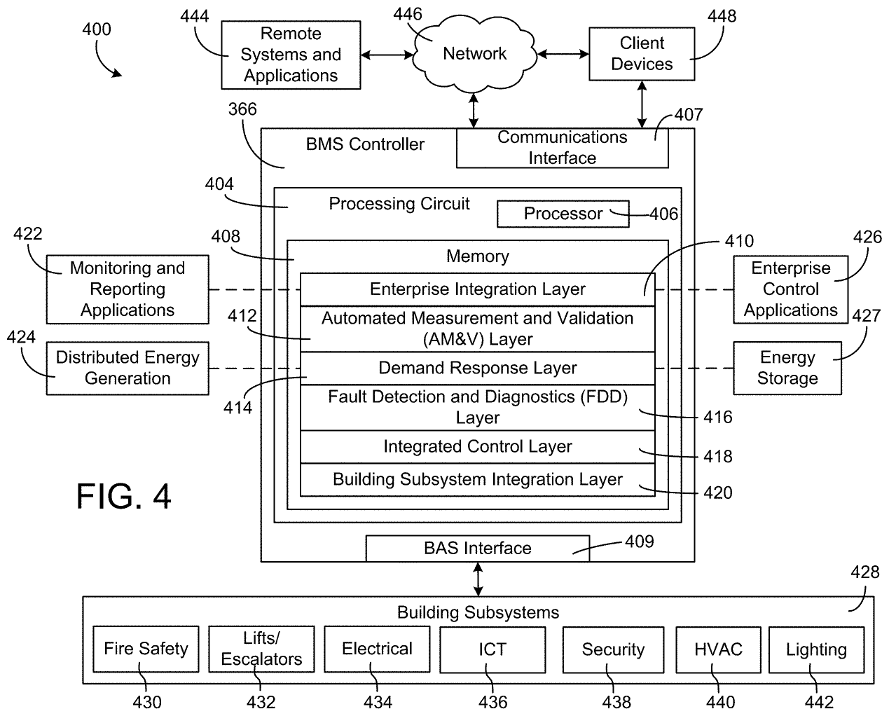

Referring now to FIGS. 1-4, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200(e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify whether control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Mixed and Augmented Reality Systems and Methods

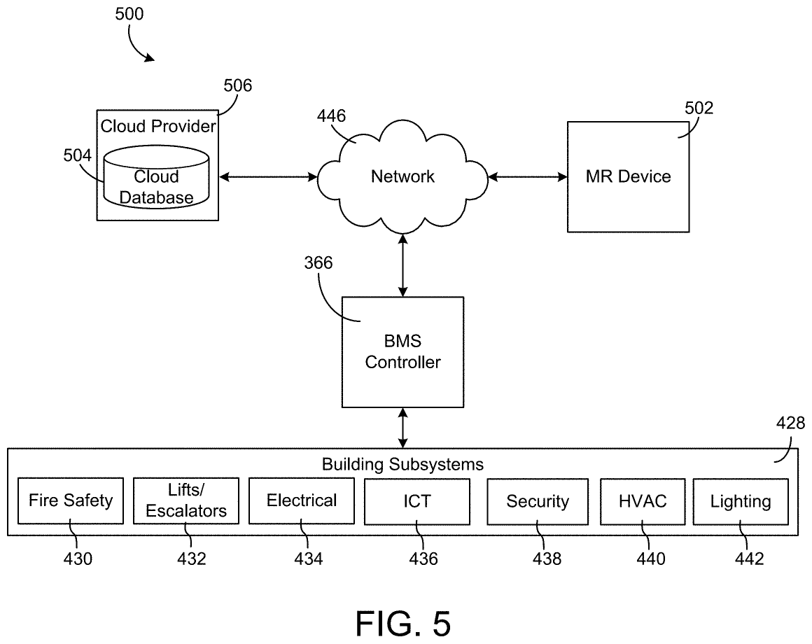

Referring generally to FIGS. 5-18, systems and methods for viewing and interacting with building management system (BMS) data are shown, according to some embodiments. Integrating mixed reality (MR) with a BMS (e.g., BMS 400) can provide a user with real-time feedback of building equipment in the BMS, allowing a user to identify fault statuses, current operating conditions, and/or any other pertinent information regarding the building equipment that can be useful to the user. As discussed in greater detail below, models (e.g., 2-D models, 3-D models, etc.) can be stored on a database and accessed to be displayed in an MR settings (e.g., via a MR headset worn by a user). In particular, the database can be a cloud database that stores the models and can be accessed to retrieve an appropriate model to display to a user. In some embodiments, the cloud database stores real-time data describing the building equipment and/or the BMS. By hosting the models and the real-time data on the cloud database, MR can be integrated with the BMS and can be provided to users across a building (e.g., building 10) associated with the BMS. Further, by incorporating the cloud database, users can access the device models and/or data (e.g., historic data, real-time data, etc.) remotely. Advantageously, remote access can allow users to monitor components of the BMS, display products for potential customers, train in repairing components of the BMS, etc. without a need to be physically located at the building.

Referring now to FIG. 5, a block diagram of a communication system 500 including a mixed reality (MR) device 502 is shown, according to some embodiments. Although FIG. 5 includes MR device 502, it is to be understood that an augmented reality (AR) device can communicate in the same or a similar manner as MR device 502. As shown, communications system 500 includes network 446, which may be in communication with MR device 502. Additionally, network 446 may be in communication with a cloud database 504 hosted by a cloud provider 506 and/or BMS controller 366. In some embodiments, cloud provider 506 is configured to perform some and/or all of the functionality of BMS controller 366 described herein. In some embodiments, BMS controller 366 may be in communication with building subsystems 428, which may include building electrical subsystem 434, information communication technology (ICT) subsystem 436, security subsystem 438, HVAC subsystem 440, lighting subsystem 442, lift/escalators subsystem 432, and fire safety subsystem 430. As previously discussed, building subsystems 428 can include fewer, additional, or alternative subsystems.

Network 446 can include any appropriate network to facilitate data transfer between cloud provider 506, MR device 502, and BMS controller 366. For example, network 446 may include the Internet such that MR device 502 and/or BMS controller 366 can communicate with cloud provider 506 via the Internet. As another example, network 446 may include an internal building network over which MR device 502 and BMS controller 366 can exchange data. In this way, network 446 can include wired and/or wireless connections between any of cloud provider 506, MR device 502, and BMS controller 366.

Still referring to FIG. 5, MR device 502 may send and receive data from cloud database 504 and/or BMS controller 366 via network 446. In some embodiments, for example, BMS controller 366 may provide MR device 502 with real-time data from building subsystems 428 (e.g., equipment faults, operating values, power status, etc.). In some embodiments, cloud database 504 may be configured to store historical and/or general information pertaining to building subsystems 428. Specifically, in some embodiments, cloud database 504 may store 2-dimensional and/or 3-dimensional models of equipment within building subsystems 428. Further, cloud database 504 may store operational history of equipment within building subsystems 428 (e.g., fault logs, power consumption, inputs and/or outputs, etc.).

BMS controller 366 can gather various operating information describing building subsystems 428 to provide to cloud database 504. Some and/or all the operating information provided to cloud database 504 can be timestamped to indicate a time when the operating information is gathered. Cloud provider 506 can be any various cloud provider that MR device 502 and/or BMS controller 366 can communicate with via network 446. In some embodiments, cloud provider 506 represents multiple cloud providers that can provide data processing and data storage services. In some embodiments, cloud database 504 represents multiple cloud database that can store equipment models, historic data, real-time data, etc. By storing information describing building subsystems 428 on cloud database 504, functionality of BMS controller 366 can be simplified, thereby reducing an amount of processing power required to perform the functionality of BMS controller 366. In particular, by storing information describing building subsystems 428 on cloud database 504, BMS controller 366 can reduce an amount of processing required to parse through the data as said functionality can be handled by cloud provider 506 hosting cloud database 504. In this way, cloud provider 506 can include one or more processing circuits that can perform some and/or all of the functionality of cloud provider 506 described herein. Likewise, BMS controller 366 can reduce an amount of data storage necessary to provide full functionality as building equipment information can be stored in part and/or exclusively on cloud database 504.

In some embodiments, MR device 502 sends and receives real-time data from full-site systems (e.g., full buildings, multiple buildings, multiple sites, etc.). This can be done via communication with a number of BMS controllers (e.g., BMS controller 366), and/or a number of databases (e.g., cloud database 504). In some embodiments, BMS controller 366 determines how MR device 502 is interfacing with building subsystems 428, building 10, other building equipment, etc. based on data sent by MR device 502. If BMS controller 366 makes said determinations, BMS controller 366 can provide information regarding the determinations to cloud provider 506 to access related information. In some embodiments, processing regarding data sent by MR device 502 is facilitated by cloud provider 506.

For example, MR device 502 may output optical data and location data to BMS controller 366 and/or cloud database 504. Based on the optical data and the location data, BMS controller 366 can determine a location of MR device 502 in building 10 and can determine if MR device 502 is observing any building equipment and/or other components of BMS 400. Based on said determinations, BMS controller 366 can provide an indication to cloud provider 506 to access any models related to building equipment that BMS controller 366 determines MR device 502 may be facing/near. Based on the indication, cloud provider 506 can access associated building models from cloud database 504 to provide to MR device 502 via network 446. Likewise, any inputs (e.g., gestures, voice commands, etc.) issued by the user of MR device 502 can be provided to cloud provider 506 and/or BMS controller 366 to determine what subsystems, data, etc. should be manipulated based on said inputs.

In some embodiments, cloud provider 506 is responsible for managing visual information displayed on MR device 502. In this way, MR device 502 can receive video data from cloud provider 506 via network 446 to display on a visual display (also referred to as an optimal projection system) of MR device 502. For example, if cloud provider 506 determines MR device 502 is directed towards an HVAC device of HVAC subsystem 440, cloud provider 506 can provide video data including diagnostics, fault statuses, historical data, etc. regarding the HVAC device to overlay on the visual display of MR device 502. In this way, the user of MR device 502 can receive pertinent information of the HVAC device simply by facing MR device 502 towards the HVAC device. If cloud provider 506 is responsible for managing visual information displayed on MR device 502, BMS controller 366 and/or MR device 502 can reduce required processing power to perform functionality described herein as intensive processing requirements for generating video data can be handled by cloud provider 506. In some embodiments, video processing is handled by BMS controller 366 and/or MR device 502.

Communication system 500 may be configured to send data from memory (e.g., a cloud-based server, cloud database 504, memory 408) to MR device 502. Accordingly, a real-time and/or a historical state of equipment (e.g., building subsystems 428) may be simulated for a user via MR device 502. In particular, cloud provider 506 may provide historical data stored in cloud database 504 to MR device 502. In some embodiments, BMS controller 366 provides the real-time data to MR device 502 directly via network 446. In some embodiments, BMS controller 366 provides the real-time data to cloud provider 506 initially for processing. In this way, cloud provider 506 can then provide the real-time (or substantially real-time) data to MR device 502 (e.g., as video data). As such, MR device 502 can acquire frequently updated data regarding the equipment and display said data on the visual display.

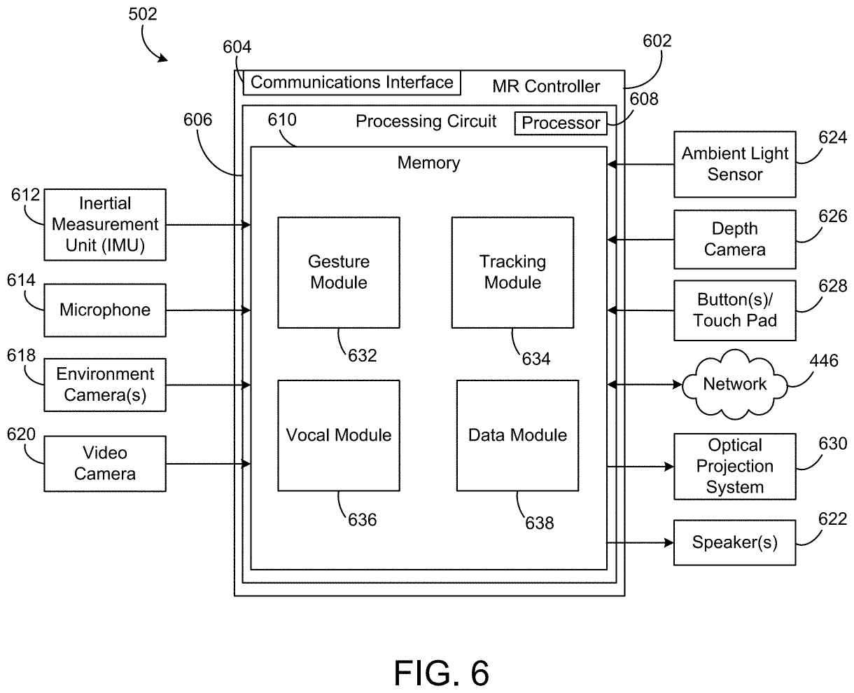

In some embodiments, MR device 502 may request information from cloud database 504 and/or BMS controller 366 via network 446. The request for information may correspond to a user input to MR device 502. For example, the user may make a hand gesture while facing a light of lighting subsystem 442. The hand gesture can be provided to cloud database 504 and/or BMS controller 366 for processing. In this case, cloud provider 506 may process the hand gesture to indicate the light should switch from an on state to an off state and provide an appropriate control message to BMS controller 366 in order to turn the light off. Methods of requesting and receiving information via MR device 502 are described in greater detail with reference to FIGS. 6-8 and 18.

Referring now to FIG. 6, MR device 502 is shown in greater detail, according to some embodiments. MR device 502 is shown to include a MR controller 602. MR controller 602 is shown to include a communications interface 604. Communications interface 604 may facilitate communications between MR controller 602 and external applications (e.g. BMS controller 366, cloud database 504, etc.).

Communications interface 604 can be or include wired or wireless communications interfaces (e.g., jacks, antennas, transmitters, receivers, transceivers, wire terminals, etc.) for conducting data communications with BMS controller 366 or other external systems or devices. In various embodiments, communications via communications interface 604 can be direct (e.g., local wired or wireless communications) or via a communications network (e.g., network 446, a WAN, the Internet, a cellular network, etc.). For example, communications interface 604 can include an Ethernet card and port for sending and receiving data via an Ethernet-based communications link or network. In another example, communications interface 604 can include a Wi-Fi transceiver for communicating via a wireless communications network. In another example, communications interface 604 can include cellular or mobile phone communications transceivers. In one embodiment, communications interface 604 is an Ethernet interface. Communications interface 604 can facilitate communication between MR controller 602 and other controllers, systems, etc. via network 446.

Still referring to FIG. 6, MR controller 602 is shown to include a processing circuit 606 including a processor 608 and memory 610. Processing circuit 606 can be communicably connected to communications interface 604 such that processing circuit 606 and the various components thereof can send and receive data via communications interface 604. Processor 608 can be implemented as a general purpose processor, an application specific integrated circuit (ASIC), one or more field programmable gate arrays (FPGAs), a group of processing components, or other suitable electronic processing components.

Memory 610 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 610 can be or include volatile memory or non-volatile memory. Memory 610 can include database components, object code components, script components, or any other type of information structure for supporting the various activities and information structures described in the present application. According to some embodiments, memory 610 is communicably connected to processor 608 via processing circuit 606 and includes computer code for executing (e.g., by processing circuit 606 and/or processor 608) one or more processes described herein. In some embodiments, one or more components of memory 610 are part of a single component. However, each component of memory 610 is shown independently for ease of explanation. In some embodiments, memory 610 includes more or fewer components than as shown in FIG. 6. In some embodiments, MR controller 602 is implemented within a single computer (e.g., one server, one housing, etc.). In some situations, for example, MR controller 602 may be within MR goggles and/or glasses.

As shown, MR controller 602 can be configured to accept inputs from various devices and sensors. Further, MR controller 602 may provide outputs to additional systems (e.g., optical projection system 630, speakers 622, etc.). In some embodiments, MR device 502 includes an inertial measurement unit (IMU) 612, a microphone 614, an environment camera(s) 618, a video camera 620, a speaker(s) 622, an ambient light sensor 624, a depth camera 626, a button(s)/touch pad 628, and/or an optical projection system 630. Further, MR controller 602 may communicate with additional devices, servers, etc. via network 446.

Still referring to FIG. 6, memory 610 is shown to include a gesture module 632, a tracking module 634, a vocal module 636, and a data module 638. In some embodiments, gesture module 632, tracking module 634, vocal module 636, and/or data module 638 may utilize inputs from inertial measurement unit (IMU) 612, microphone 614, environment camera(s) 618, video camera 620, ambient light sensor 624, depth camera 626, button(s)/touch pad 628, and/or network 446 to provide corresponding outputs to optical projection system 630, and/or speakers 622. Modules 632, 634, 636, and 638 will be described in greater detail below.

In some embodiments, inertial measurement unit (IMU) 612 may be configured to measure a user's physical force, angular rate, and/or the magnetic field surrounding the user. Accordingly, IMU 612 may include devices such as accelerometers, gyroscopes, and/or magnetometers. Measurements taken by IMU 612 may be utilized by MR controller 602 to track user movement while projecting images via optical projection system 630. In this way, projected images can adjust as a user of MR device 502 moves. In some embodiments, the IMU measurements are provided to cloud provider 506 via network 446 to update information provided to MR device 502 to reflect movements of the user. For example, cloud provider 506 can determine if device data describing another building device should be provided to MR device 502 due to the user turning as indicated by the IMU measurements.

In some embodiments, microphone 614 may be configured to capture vocal inputs from a user. Accordingly, microphone 614 may be used for voice control of MR device 502 and/or BMS 400. In some embodiments, there may be additional microphones configured to detect background noise. Voice control of MR device 502 may provide hand-free functionality for turning on/off power, requesting equipment information, etc. Voice controls can be provided to cloud provider 506 via network 446 to determine what actions to take based on the voice controls. For example, if a voice control detected by microphone 614 and processed by cloud provider 506 indicates a temperature in a building zone should be 72° F., cloud provider 506 can generate control signals to provide to BMS controller 366 to adjust operation of building equipment to achieve a temperature of 72° F. in the building zone.

In some embodiments, environment camera(s) 618 may be included in a “sensor bar” in MR device 502. Environment camera(s) 618 may be configured to provide a basis for user tracking. For example, environment camera(s) 618 may capture a user's surroundings, which enables MR controller 602 to customize how output data is presented to the user. In some situations, MR device 502 may include four environment camera(s) 618. Alternatively, more or less than four environment camera(s) 618 may be included.

In some embodiments, video camera 620 may be configured to record images while a user interacts with MR device 502. Image recordings may be stored locally (e.g., in memory 610), and/or may be stored remotely (e.g., on cloud database 504) via network 446. In some embodiments, a user may choose to enable and disable video camera 620.

In some embodiments, speaker(s) 622 may be configured to output audio to a user while a user interacts with MR device 502. Speaker(s) 622 may be configured to provide audio to only the current user, or alternatively, to the general surroundings as well as the current user. In some embodiments, data module 638 of MR controller 602 determines what audio to provide to speaker(s) 622 as described in greater detail below. In some embodiments, cloud provider 506 and/or BMS controller 366 provide audio to project through speaker(s) 622 via network 446. For example, if cloud provider 506 determines a fire sprinkler of fire safety subsystem 430 is failing based on real-time data provided by BMS controller 366, cloud provider 506 may provide an alarm sound to MR device 502 to project over speaker(s) 622 in order to get the user's attention that the fire sprinkler should be replaced.

In some embodiments, ambient light sensor 624 may be configured to sense light from surroundings while a user interacts with MR device 502. In some embodiments, ambient light sensor 624 may be used to adjust how the output data is presented to the user. For example, if ambient light sensor 624 detects a low amount of light in a space, optical projection system 630 may decrease a brightness of output data presented to the user as the output data may be easier to see in dim lighting. In some embodiments, lighting information gathered by ambient light sensor 624 is provided to cloud provider 506 and/or BMS controller 366. BMS controller 366 can utilize the lighting information to determine, for example, performance information of lighting equipment in building 10 to provide as additional data to cloud provider 506 to store in cloud database 504.

In some embodiments, depth camera 626 may be configured to determine distances (e.g., “depth”) while a user interacts with MR device 502. These spatial determinations may be used by MR controller 602 to adjust how output data is presented to the user. As one example, if the MR device 502 is five feet from a wall, an output projection may be confined to four feet. In contrast, if the MR device 502 is ten feet from a wall, an output projection may extend beyond four feet.

Although a user may interact with MR device 502 via microphone 614, MR device 502 may further include button(s)/touch pad 628. In some embodiments, for example, a user may press a button (e.g., button 628) to turn on/off MR device 502. Further, in some embodiments, a user may use a touch pad (e.g., touch pad 628) to adjust a volume corresponding to speaker(s) 622. As another example, a button (e.g., button 628) may be configured to turn on/off video camera 620. Additional functions may be implemented via button(s)/touch pad 628.

Still referring to FIG. 6, memory 610 is shown to include gesture module 632. In some embodiments, gesture module 632 may be configured to use one or more inputs to determine that a user gesture has occurred. Further, in some embodiments, gesture module 632 may be configured to determine an output corresponding to a user gesture, which may then be provided to optical projection system 630, network 446, and/or speaker(s) 622. In some situations, for example, gesture module 632 may use input data from inertial measurement unit (IMU) 612, environment camera(s) 618, video camera 620, and/or depth camera 626. As one non-limiting example, a user may swipe their hand from left to right in view of MR device 502. Gesture module 632 may determine that this user gesture indicates that the current output projection should be rotated. Accordingly, gesture module 632 may communicate with optical projection system 630 to rotate the projection.

In some embodiments, some and/or all user gestures determined by gesture module 632 are provided to cloud provider 506. For example, gesture module 632 may only provide a set of user gestures related to historical and real-time data to cloud provider 506. Based on the user gestures received, cloud provider 506 can determine appropriate actions to take based on the received user gestures. For example, a user may point at a building device in view of MR device 502, thereby indicating the user desires additional historical data regarding the building device. Gesture module 632 can provide the pointing gesture to cloud provider 506 via network 446. Based on the point gesture, cloud provider 506 can provide historical data of the building device stored in cloud database 504 and provide the historical data to MR device 502 to be displayed on optical projection system 630. Additional inputs may be utilized by MR controller 602 to determine user gestures, in addition to the ones shown in FIG. 6.

Memory 610 is shown to further include tracking module 634. In some embodiments, tracking module 634 may be configured to use one or more inputs to determine if user movement has occurred. In some situations, user movement is distinct from a user gesture (e.g., a user moving their head may be considered a user movement, whereas a user deliberately moving their hands may be considered a user gesture).

Further, in some embodiments, tracking module 634 may be configured to determine an output corresponding to a user movement, which may then be provided to optical projection system 630, network 446, and/or speaker(s) 622. In some situations, for example, tracking module 634 may use input data from inertial measurement unit (IMU) 612, environment camera(s) 618, video camera 620, and/or depth camera 626. As one non-limiting example, a user may tilt their head while wearing an embodiment of MR device 502. Using data from IMU 612, tracking module 634 may determine the degree of the head tilt. Accordingly, tracking module 634 may communicate with optical projection system 630 to preserve how the user sees the projected data (e.g., the projection may stay fixed relative to the environment, even though the user is moving). Additional inputs may be utilized by MR controller 602 to determine user movements, in addition to the ones shown in FIG. 6.

Still referring to FIG. 6, memory 610 is shown to include vocal module 636. In some embodiments, vocal module 636 may be configured to use one or more inputs to determine that a vocal input has occurred (e.g., a voice command issued by a user). Further, in some embodiments, vocal module 636 may be configured to determine an output corresponding to the vocal input, which may then be provided to optical projection system 630. In some situations, for example, vocal module 636 may use input data from microphone 614. As one non-limiting example, a user may speak a “trigger word” (i.e., a word that may indicate to MR controller 602 that a command will follow) into microphone 614, followed by a vocal command. Using the voice data, vocal module 636 may determine an output that corresponds to the voice data. Accordingly, vocal module 636 may communicate with optical projection system 630 to update projected data. Additional elements (e.g., inputs, modules) may be utilized by MR controller 602 to determine and interpret vocal inputs.

In some embodiments, vocal inputs determined by vocal module 636 are provided to cloud provider 506 and/or BMS controller 366. For example, a vocal command from a user indicating a lift of lifts/escalators subsystem 432 should move up a floor of building 10 can be provided to BMS controller 366 which can operate the lift. Alternatively, the vocal command can be provided to cloud provider 506 which can generate a command to provide to the lift via BMS controller 366. As another example, a vocal command indicating a request for all data describing a building device can be provided to cloud provider 506 which can access the data from cloud database 504 and provide the data back to MR device 502. In this way, the user can directly interface with cloud provider 506 via MR device 502.

Memory 610 is shown to include data module 638. In some embodiments, data module 638 may be configured to use one or more inputs to determine what data is needed to create a projection. Further, in some embodiments, data module 638 may communicate with external devices via network 446 to obtain data. Data module 638 may be further configured to send data to optical projection system 630 and/or speaker(s) 622. For example, a user may request to view the current operation of a chiller (e.g., chiller 102). Data module 638 may retrieve a model (e.g., a 2-D or 3-D model) via network 446 (e.g., from cloud database 504). In addition, data module 638 may retrieve current operating data of the chiller via network 446 (e.g., from BMS controller 366 or cloud provider 506). The retrieved data may then be provided to optical projection system 630, for viewing by the user.

In some embodiments, as a user moves, data module 638 dynamically updates what information is being provided to a user via optical projection system 630 and/or speaker(s) 622. For example, if a user moves from a first room of building 10 to a second room of building 10, data module 638 may request new data from cloud provider 506 regarding building devices in the second room. In particular, data module 638 can request a model associated with each building device to ensure relevant information is provided to the user regardless of a position in building 10.

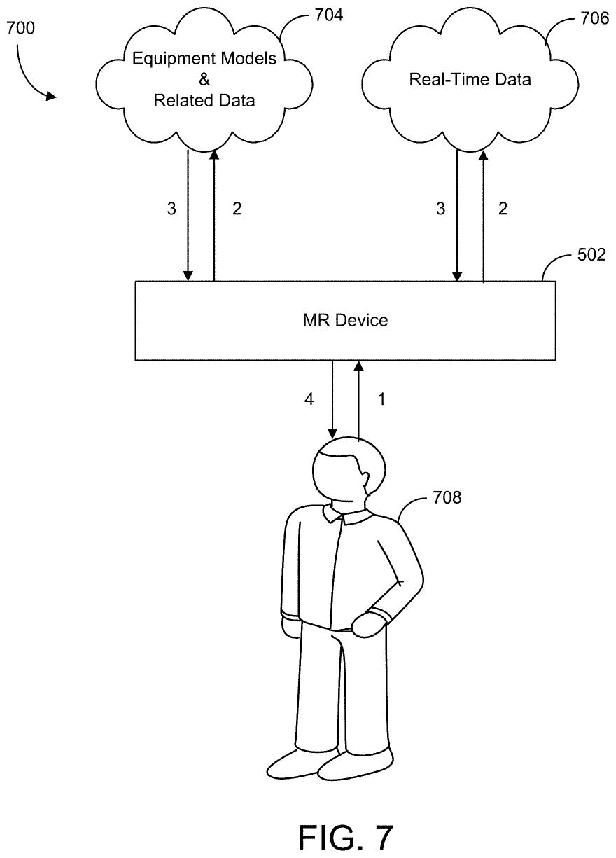

As shown, MR device 502 includes optical projection system 630, which receives outputs from memory 610. In some embodiments, optical projection system 630 may include microdisplays (projectors), imaging optics, waveguide, a combiner, and/or gratings. In some embodiments, the projectors may be small, liquid crystal on silicon (LQoD) displays. One projector may be mounted on each lens (such as the lenses on MR glasses/goggles). The projectors may project images through imaging optics, and then the images may be coupled in through the diffraction grating, where the image gets diffracted inside the waveguide. Next, the image may be “out-coupled” (e.g., the projected image may be combined with real world images via the combiner). The output of optical projection system 630 may appear to the user as a 3-dimensional hologram. In some embodiments, the user may interact with the hologram, and optical projection system 630 may respond accordingly. Example embodiments of an MR device are described below, with respect to FIGS. 7-13.

Another implementation of the present disclosure is an AR device. The AR device may be similar to MR device 502. As described above, an AR device may overlay virtual elements onto an image of the real world. In contrast, MR device 502 may overlay virtual elements onto an image of the real world, and also enable a user to directly interact with the projection (e.g., a hologram). In some embodiments, MR device 502 may be worn by a user. In some embodiments, the AR device may be held by a user. For example, MR device 502 may be a mixed reality headset whereas the AR device may be a smartphone or tablet that can be held by the user.

The AR device may include a display configured to show projected data on top of real world images. Further, in some embodiments, the data may be projected onto real-time images gathered by the AR device. Accordingly, the AR device may include similar inputs and/or modules as MR device 502. Specifically, the AR device may include a microphone, environment cameras, a video camera, an ambient light sensor, a depth camera, and button(s)/touch pad. The AR device may not include an optical projection system. Instead, the AR device may include an output display. The AR device may additionally include speaker output(s), similar to MR device 502.

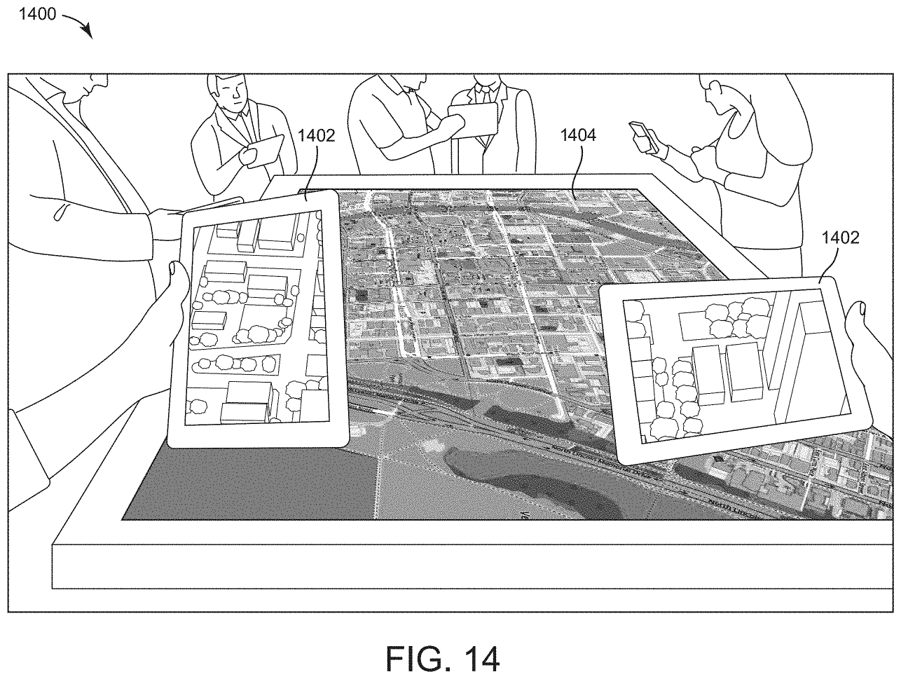

The AR device may further include a communications interface, AR controller, processing circuit, processor, and/or memory, which may be similar to those described with respect to FIG. 6. The memory may include a plurality of modules, which may be the same or similar to the modules described with respect to FIG. 6. In some embodiments, the AR controller may not include a gesture module. When used as a hand-held device, monitoring user gestures may not be beneficial. Instead the AR controller can capture user input via other means such as by touch inputs on a touchscreen of the AR device. In some embodiments, a data module may be used to retrieve operating data, but not 2-D or 3-D models of the equipment. Instead, the various cameras may capture images of the equipment near the AR device (e.g., a user holds up the AR device in front of a chiller and is able to see the chiller on the display, as well as current operating data overlaid on the live image). Example embodiments of the AR device are described below, with respect to FIGS. 14-16.

Referring now to FIG. 7, an example embodiment of an MR system 700 is shown, according to some embodiments. MR system 700 is shown to include MR device 502 as described with reference to FIGS. 5-6, a user 708, a cloud services 704, and a cloud service 706. In some embodiments, cloud service 704 and cloud service 706 are a single cloud service. In some embodiments, cloud service 704 and/or cloud service 706 are similar to and/or the same as cloud service provider 506.

MR system 700 can illustrate how MR device 502 can communicate with cloud services 704 and 706 to exchange information regarding BMS 400. Cloud service 704 is shown to store equipment models and related data. The equipment models can include 2-D models, 3-D models, and/or any other models that can be used by MR device 502 base information provided to user 708 on. For example, cloud service 704 can store (e.g., in a cloud database) a 3-D model of a heating unit that includes what information of the heating unit to display, in what order to display the information, colors associated with operating states of the heating unit, etc.

Cloud service 706 is shown to store real-time data related to BMS 400. The real-time data can describe data actively being gathered by BMS controller 366 describing building subsystem 428, other building equipment, and/or any other information describing building 10 and/or components of building 10. BMS controller 366 may provide the real-time data to cloud service 706 for storage and/or processing before being provided to MR device 502. For example, cloud service 706 may store the real-time data in a cloud database (e.g., cloud database 504) and determine a portion of the real-time data to provide to MR device 502. The portion of the real-time data to provide to MR device 502 can be determined based on information regarding MR device 502 such as, for example, a location of MR device 502, visual data indicating what MR device 502 is directed towards, requests for certain portions of the real-time data by a user, etc. If MR device 502 does not require all of the real-time data gathered by BMS controller 366, it may be inefficient to provide all of the real-time data to MR device 502. For example, MR device 502 may only require real-time data regarding building devices in a room that MR device 502 is currently in rather than all rooms in building 10.

MR system 700 is shown to include user 708 selecting data to be displayed on MR device 502 (e.g., step 1). The selection provided by user 708 can include a request for a geographic information (e.g., information related to a space of building 10), site and equipment information, information of a product, etc. to be displayed on a visual display of MR device 502. For example, if user 708 desires to inspect a new building device to determine if they desire to purchase the building device, user 708 may request a 3-D model of the building device to be displayed on the visual display. As another example, if user 708 is about to inspect building 10 to determine if any building equipment is experiencing a fault status, user 708 may request for all real-time data of building equipment within a certain proximity of a current geographical location of user 708 in building 10.

MR system 700 is also shown to include MR device 502 requesting data corresponding to the selection from cloud services 704 and 706 (e.g., step 2). Based on the selection of user 708 in step 1, MR device 502 can determine which of cloud service 704 and 706 store data that can be used to fulfill the selection. In some embodiments, MR device 502 sends the request to both cloud services 704 and 706 regardless of the selection. In this case, cloud service 704 and 706 can determine what information to provide back to MR device 502 based on the request.

In some embodiments, cloud services 704 may receive the data request, and provide MR device 502 with models (e.g., 2-D or 3-D models) and/or other known data corresponding to the request (e.g., step 3). Further, in some embodiments, cloud services 706 may receive the data request, and provide MR device 502 with real-time data corresponding to the request (e.g., step 3). In general, cloud services 704 and 706 can determine what information to provide to MR device 502 to fulfill the request.

MR system 700 is also shown to include MR device 502 displaying the received data to user 708 (e.g., step 4). Based on the received data, MR device 502 can determine how to display the information on the visual display such that user 708 can access the information. In some embodiments, the received data is provided to user 708 as audio through a speaker of MR device 502.

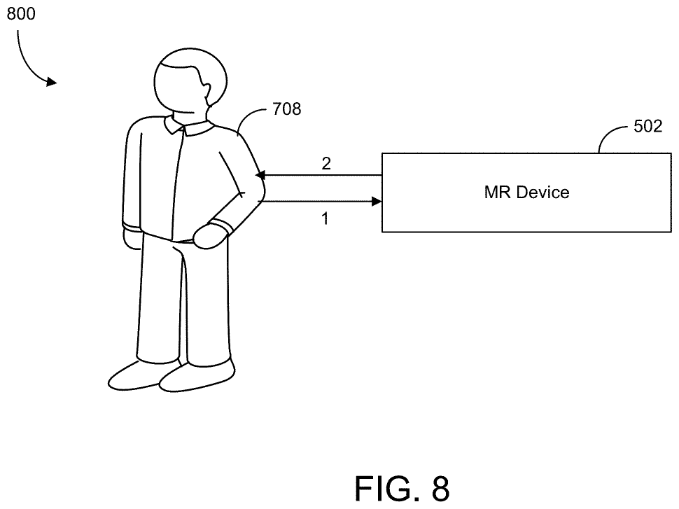

Referring now to FIG. 8, an example embodiment of an MR system 800 is shown. MR system 800 of FIG. 8 is shown to include user 708 and MR device 502 as described above with reference to FIG. 7. In some embodiments, MR system 800 is similar to and/or the same as MR system 700 as described with reference to FIG. 7.

MR system 800 is shown to include user 708 providing MR device 502 with real-time data (e.g., step 1). The real-time data provided by user 708 can include, for example, real-time site data, real-time equipment data, real-time product data, etc. By providing MR device 502 with real-time data, user 708 can effectively provide the real-time data to cloud service 704 and/or 706 to store and/or process as MR device 502 can facilitate said communication. In this way, user 708 can provide real-time data that a BMS controller (e.g., BMS controller 366) may not have access to. For example, user 708 may provide real-time user feedback describing observations made by user 708 of building equipment such that the real-time user feedback can be stored in a database of cloud service 706. In some embodiments, user 708 provides and receives real-time data via an outside application (e.g., a connected chiller application). In some embodiments, the real-time data provided by user 708 is stored and/or used by MR device 502 to update visual information provided to user 708.

MR system 800 is also shown to include user 708 interacting with an output of MR device 502 (e.g., step 2). Interaction with the output can include actions such as, for example, viewing historic reports, seeing a model of the selected device, interacting with the model, etc. In some embodiments, user 708 may interact with an output of MR device 502 using vocal inputs and/or gestures (e.g., as described with respect to FIG. 6).

Referring generally to FIGS. 7-8, MR system 700 and/or MR system 800 may demonstrate the intricacies and/or functionality of heavy equipment (e.g., YMC2 & YCAV chillers), and may simulate the real-time and/or historic behavior of the equipment from the data extrapolated from cloud services 704 and 706. Accordingly, MR system 700 and/or MR system 800 may enable a learner (e.g., user 708) to perform a series of troubleshooting steps. In this way, the learner may practice troubleshooting skills while MR system 700 and/or MR system 800 emulates a real life scenario. Advantageously, a learner does not need to be physically located by the equipment in order to interact with it. In some embodiments, using MR system 700 and/or MR system 800 may provide foundational troubleshooting skills using object recognition and 3D simulated environments. This can allow for a direct application between the “classroom” experience and field service solutions. This direct application can remove the traditional barriers between two distinct environments (e.g., classroom and field).

In some embodiments, cloud services 704 and 706 include a central repository, which enables users to experience and/or interact with entire products lines via MR device 502. As one example, potential customers may be able to view and engage with multiple equipment options, prior to purchasing desired equipment. Accordingly, MR device 502 may be used as a powerful sales tool. Further, cloud services 704 and 706 can be updated as equipment is modified and/or new products become available. MR device 502 may provide instant access to the latest updates (e.g., via network 446). In some embodiments, MR device 502 provides an additional layer of safety for users and customers (e.g., viewing remotely eliminates the need for the user to physically interact with equipment).

Connecting cloud services 704 and 706 with MR device 502 can provide user 708 with access to historic equipment data, real-time equipment data, building equipment models, etc. as desired so long as MR device 502 can access cloud services 704 and 706 (e.g., with an active internet connection). Advantageously, connecting cloud service 704 and 706 with MR device 502 can allow user 708 to access building and equipment data remotely or on-site at regardless of time. Likewise, connecting cloud service 704 and 706 can reduce processing requirements of MR device 502 and/or for BMS controller 366.

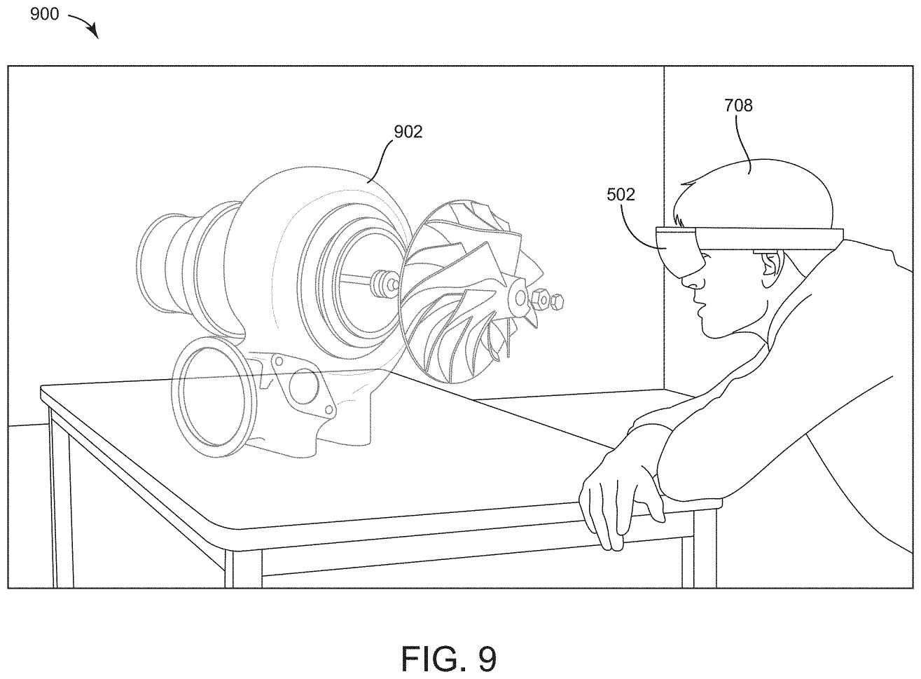

Referring now to FIG. 9, an example illustration 900 of user 708 interacting with MR device 502 is shown, according to some embodiments. Here, user 708 is wearing MR device 502, which enables user 708 to view and interact with model projections (e.g., holograms). As shown, user 708 is able to observe the function of projected equipment 902, from the convenience of an existing workspace. Accordingly, in some embodiments, user 708 can troubleshoot the equipment and/or learn about the equipment functions via MR device 502. In some embodiments, MR device 502 may be used for research and development, in addition to experiential learning.

A model for projected equipment 902 can be received from a cloud service (e.g., cloud service 704). In some embodiments, if MR device 502 moves within a certain proximity of the equipment (e.g., 2 feet, 5 feet, etc.), MR device 502 may automatically request for the model and associated data (e.g., historic data, real-time data, etc.) such that MR device 502 can display the model for user 708. In some embodiments, user 708 performs an action (e.g., a hand gesture, a voice command, a button press, etc.) to request the model and the associated data for projected equipment 902. Based on the action, MR device 502 can generate a respective request to provide to the cloud service as to retrieve the model and the associated data. In some embodiments, MR device 502 receives the model and the associated data based on a separate determination that MR device 502 requires the model and the associated data.

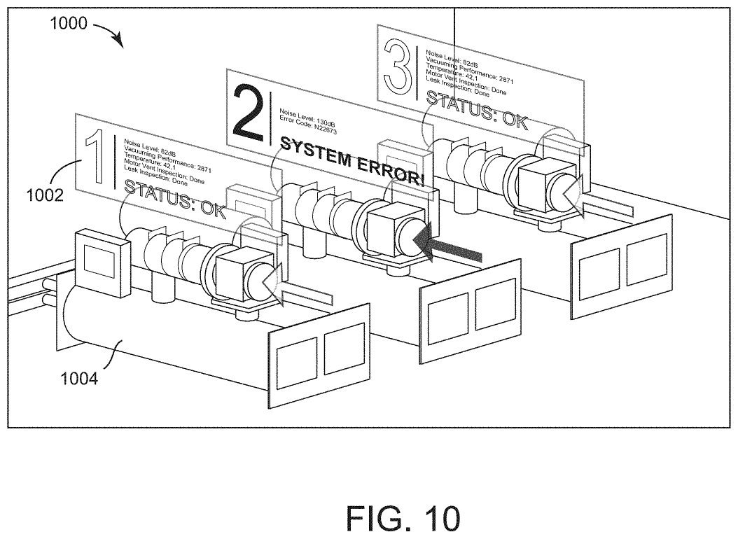

Referring now to FIG. 10, an example illustration 1000 of a perspective of user 708 while wearing MR device 502 is shown, according to some embodiments. Here, user 708 is wearing MR device 502, which enables them to view the status (e.g., normal, fault, etc.) of equipment as they walk through a facility. In particular, example illustration 1000 is shown to include a diagnostic panel 1002 relating to a building device 1004. Diagnostic panel 1002 can be generated by MR device 502 based on a 2-D model associated with building device 1004 as received from a cloud database (e.g., cloud database 504 as described with reference to FIG. 5). Further, the 2-D model can be populated with real-time data and/or historic data describing building device 1004 received from the cloud database. In some embodiments, user 708 may be on-site with building device 1004, and MR device 502 may enable them to see additional details corresponding to building device 1004 (e.g., historical data, manufacturer data, maintenance status, etc.). This functionality may increase the efficiency of engineers and/or technicians as they attempt to locate the source of a fault or problem. Further, this functionality may aid in the maintenance of existing equipment.

Similar to example illustration 900 as described with reference to FIG. 9, MR device 502 may retrieve models, historic data, real-time data, and/or other details corresponding to building device 1004 based on MR device 502 moving within a certain proximity of building device 1004, user 708 requesting the information, etc. By storing the models and other information to be displayed to user 708 via MR device 502 on a cloud database of a cloud service/provider, the models and other information can be accessed not only if user 708 is on-site, but also at off-site locations, thereby allowing any users with access to the cloud database to view a model of building device 1004 and retrieve diagnostic information of building device 1004 remotely.

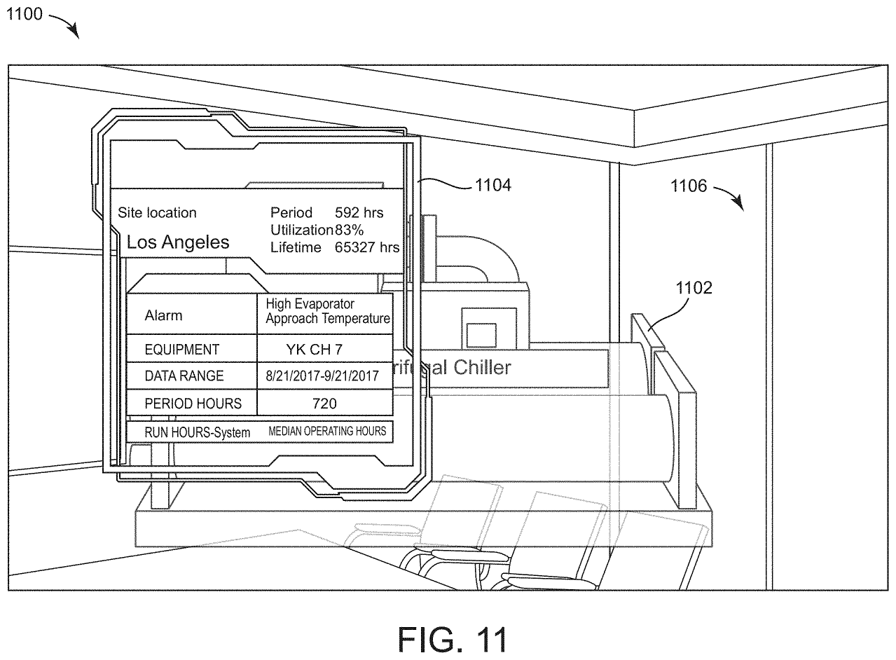

Referring now to FIG. 11, an example illustration 1100 of a perspective of user 708 while wearing MR device 502 is shown, according to some embodiments. As shown in example illustration 1100, a projected equipment 1102 is being analyzed by user 708 as displayed by MR device 502. Here, user 708 is wearing MR device 502, which enables them to view data (e.g., location, alarm status, equipment name, etc.) on an information panel 1104 that is specific to projected equipment 1102 as well as interact with projected equipment 1102 (e.g., by vocal input and/or gestures). Projected equipment 1102 can be any product, building device, etc. as requested by user 708 to be displayed. For example, projected equipment 1102 may be a chiller unit, a heating unit, an air conditioning unit, etc. A visual representation of projected equipment 1102 and information panel 1104 can be generated by MR device 502 based on one or more models received from a cloud database (e.g., cloud database 504 as described with reference to FIG. 5). For example, projected equipment 1102 may be generated based on a 3-D model of an associated building device whereas information panel 1104 may be generated based on a 2-D model of a display screen that can include populated data. As another example, a single model may include directions for displaying both projected equipment 1102 and information panel 1104.

As shown in example illustration 1100, user 708 is able to observe the function of projected equipment 1102 via information panel 1104, from the convenience of an existing space 1106 (e.g., a conference room, an office, etc.). In general, information panel 1104 can be populated with relevant historic data, real-time data, and/or other relevant data regarding projected equipment 1102 as stored by a cloud service. Accordingly, in some embodiments, user 708 can troubleshoot the equipment via MR device 502. Advantageously, by hosting models and associated information on a cloud service, a model of projected equipment 1102 and information panel 1104 along with relevant data can be retrieved from the cloud service via a network. This can allow users to access and interact with building equipment remotely. For example, projected equipment 1102 may reflect a chiller unit of a building. In this case, user 708 can issue a voice command directing the chiller unit to restart while in existing space 1106 that can be provided to the cloud service via MR device 502. Based on the received voice command, the cloud service can provide an instruction to a BMS controller (e.g., BMS controller 366) to restart the chiller unit. In this way, the chiller unit can be monitored and controlled remotely from existing space 1106 via MR device 502 and the cloud service.

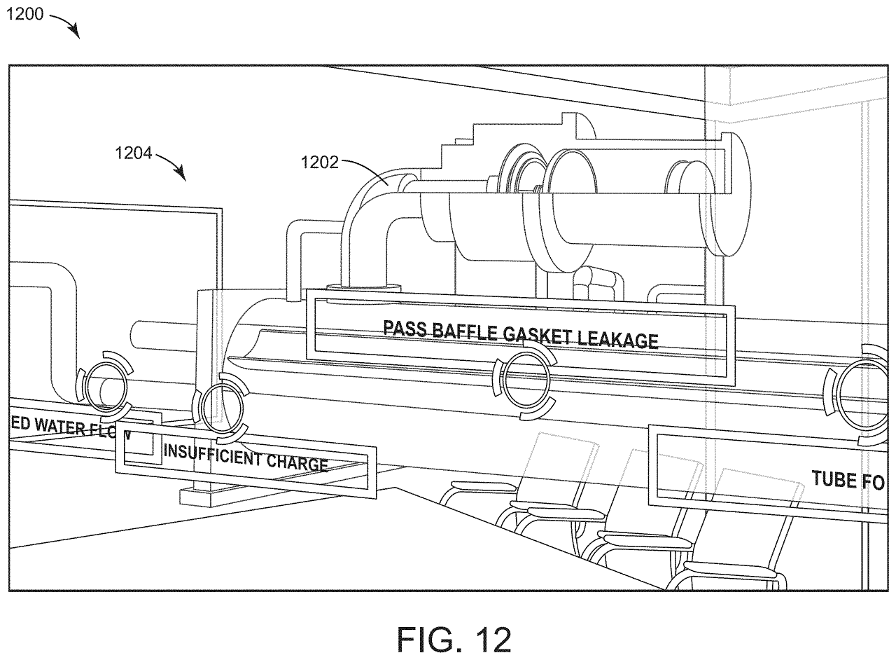

Referring now to FIG. 12, an example illustration 1200 of a perspective of user 708 while wearing MR device 502 is shown, according to some embodiments. Here, user 708 is wearing MR device 502, which enables them to view data specific to projected equipment 1202 (e.g., equipment names, potential equipment issues, faults, etc.) as well as interact with projected equipment 1202 (e.g., by vocal input and/or gestures). Projected equipment 1202 can be based on a model stored in a cloud database of any building equipment, building subsystem, etc. As shown, user 708 is able to observe the function of projected equipment 1202, from the convenience of an existing space 1204 (e.g., a conference room, a product venue, etc.). In particular, user 708 is able to see that an element has insufficient charge, and the pass baffle gasket is leaking, among other things. Accordingly, in some embodiments, the user may determine equipment-related problems using MR device 502. In some situations, for example, an “expert” can interact with a field technician and the equipment, without traveling to the equipment location. This can help to reduce equipment downtime and troubleshooting cost.

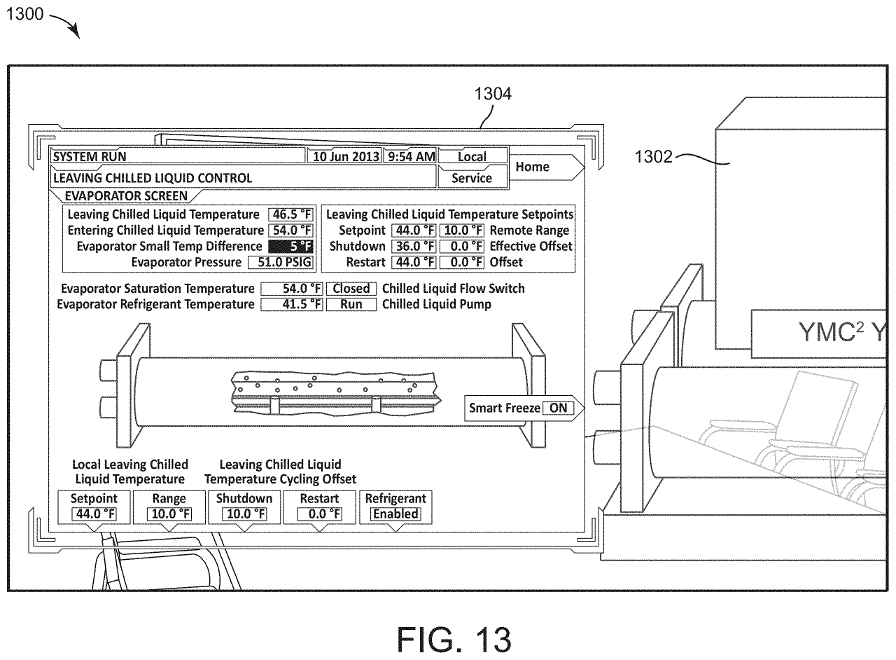

Referring now to FIG. 13, an example illustration 1300 of a perspective of user 708 while wearing MR device 502 is shown, according to some embodiments. Here, user 708 is wearing MR device 502, which enables them to view detailed historical and/or real-time data that is specific to a projected equipment 1302 on an information panel 1304. For example, as shown, user 708 may view a current temperature of a building device associated with projected equipment 1302, as well as the temperature range and temperature setpoint of the building device via information panel 1304. Further, data may be presented on information panel 1304 such that user 708 can easily determine if values are acceptable (e.g., green values are acceptable, red values are unacceptable). In some embodiments, user 708 may interact with projected equipment 1302 and/or data presented by information panel 1304. For example, user 708 may initially see a full model projection, and they can then select an area of the model to view more details. The selection can be facilitated via vocal input and/or gestures detected by MR device 502.

Referring now to FIG. 14, an example illustration 1400 of users interacting with an AR device 1402 is shown, according to some embodiments. As described above, an AR device may be similar to an MR device. As such, AR device 1402 may be similar to MR device 502 as described above with reference to FIGS. 5-13. However, instead of appearing “projected” to a user (such as with MR device 502), data may be superimposed onto an image of the object when using AR device 1402. Accordingly, a user (e.g., user 708) may hold AR device 1402, whereas the user may wear MR device 502 over their eyes (such as in FIGS. 9-13).

As illustrated in FIG. 14, a user may view images via an interface of AR device 1402, the image resulting from the user's surroundings. As shown in example illustration 1400, AR device 1402 can use images gathered from a 2-D map 1404 to generate 3-D images with additional elements superimposed. As shown, the generated 3-D image may be displayed on the interface of AR device 1402. Further, as AR device 1402 moves with respect to the map, AR device 1402 may track the movement and update the 3-D image accordingly. In some embodiments, AR device 1402 may be used for planning purposes (e.g., planning a building site, a room layout, equipment placement, etc.). In some situations, it may be beneficial to use AR device 1402, as opposed to MR device 502. For example, AR device 1402 may be useful in situations where the user will be physically located near the equipment that they intend to view. Conversely, MR device 502 may be useful in situations where the user will be physically located away from the equipment that they intend to view.

The 3-D images generated by AR device 1402 can be based on models and/or other information provided by a cloud service (e.g., cloud service 704 or cloud service 706). By using the cloud service, multiple AR devices 1402 can access the same data set to generate appropriate displays for users. In this way, as shown by example illustration 1400, multiple users can view 3-D images of 2-D map 1404 on respective AR device 1402. In this way, users are not limited to using only one AR device 1402 to view desired information.

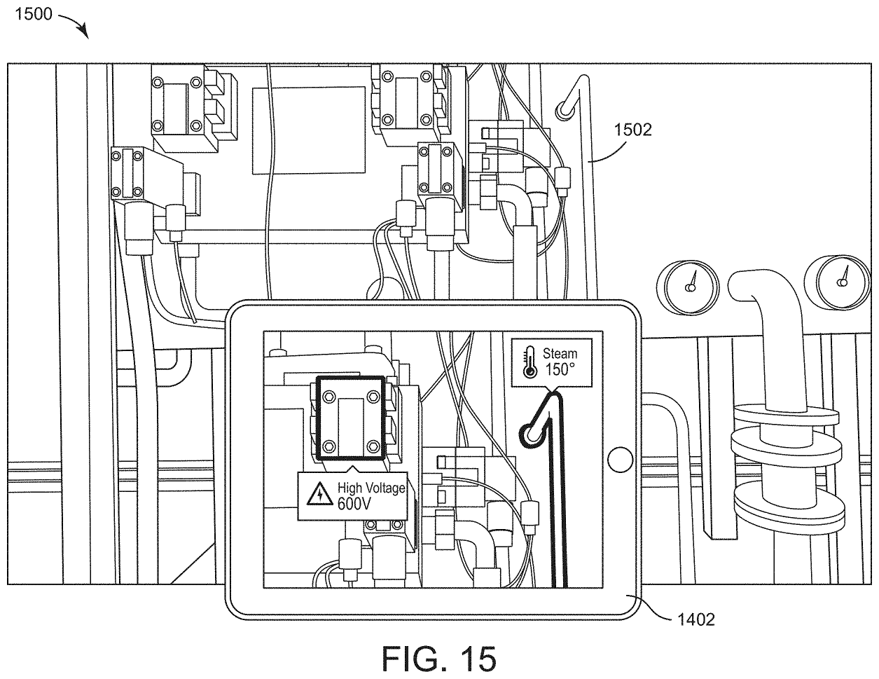

FIG. 15 is an example illustration 1500 of a user's perspective while using AR device 1402, according to some embodiments. As shown, AR device 1402 may be configured to superimpose data (e.g., data acquired from network 446, cloud database 504) over real-time images. In some embodiments, cameras (e.g., video camera 620, environment camera(s) 618) may be configured to capture real-time images. In some embodiments, the user (e.g., user 708) may hold AR device 1402 in front of equipment. AR device 1402 may then display, via an interface, a real-time image of the equipment as well as relevant data corresponding to the specific equipment.

As described throughout, the data to display on AR device 1402 can include historic data, real-time data, and/or any other data associated with the equipment as stored by cloud database 504. In some embodiments, AR device 1402 automatically requests pertinent data of the equipment from cloud database 504 based on a determination that the pertinent data is needed (e.g., based on a proximity of AR device 1402 to the equipment). In some embodiments, the user requests the pertinent data to be retrieved from cloud database 504 via an action with AR device 1402 (e.g., touching the equipment on a touchscreen of AR device 1402, clicking a button on AR device 1402, etc.).

As shown in FIG. 15, for example, a user may hold up AR device 1402 in front of operating equipment 1502, and AR device 1402 may display operating equipment 1502, as well as current data and/or highlighted areas of potential issue. Here, AR device 1402 shows a user that a device of operating equipment 1502 is operating at a high voltage (e.g., 600V), and that the steam temperature within a specific pipe is 150 degrees. In this way, AR device 1402 can be used for service and maintenance. Similarly, AR device 1402 can be used to train users how to identify equipment that is experiencing faults and/or other issues. Further, in some embodiments, AR device 1402 may send (via network 446) the generated images to a remote device, for diagnostic and troubleshooting purposes.

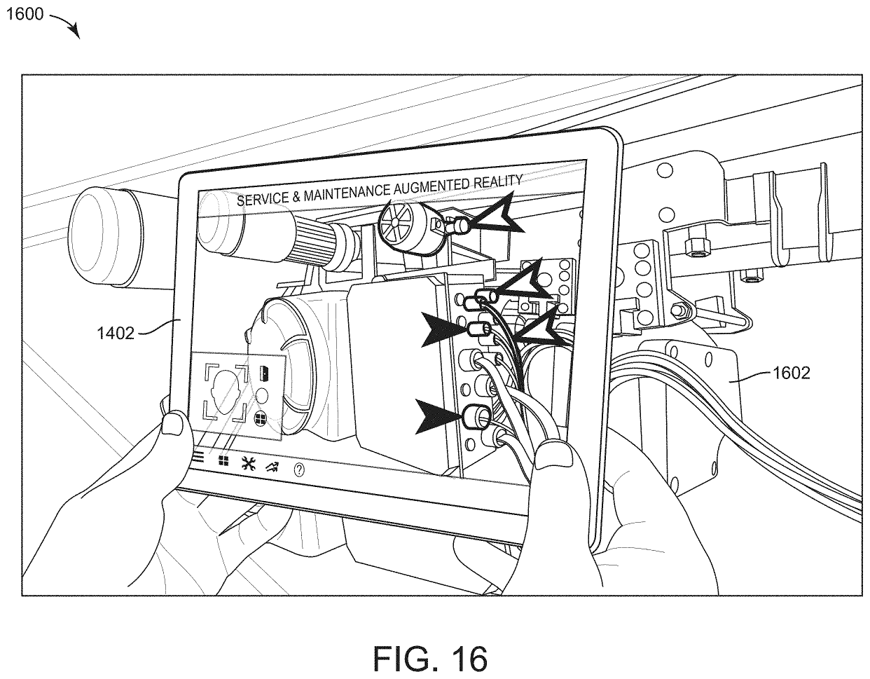

FIG. 16 is an example illustration 1600 of a user's perspective while using AR device 1402, according to some embodiments. As shown, AR device 1402 may be configured to superimpose data (e.g., data acquired from network 446, cloud database 504) over real-time images. As shown by example illustration 1600, a user may hold AR device 1402 in front of equipment 1602. AR device 1402 may then display, via an interface, a real-time image of equipment 1602 as well as relevant data corresponding to equipment 1602. For example, as shown, AR device 1402 may be configured to display a real-time image of equipment 1602, superimposed with service and/or maintenance instructions. In some embodiments, the service and/or maintenance instructions may include arrows indicating elements needing service. In some embodiments, certain components are highlighted in colors to indicate an operating status of each component (e.g., green can indicate normal operation, red can indicate an issue). Further, each time a user alters equipment 1602, the generated image may be updated to show the next step and/or instruction. In some embodiments, installation instructions are provided via AR device 1402.

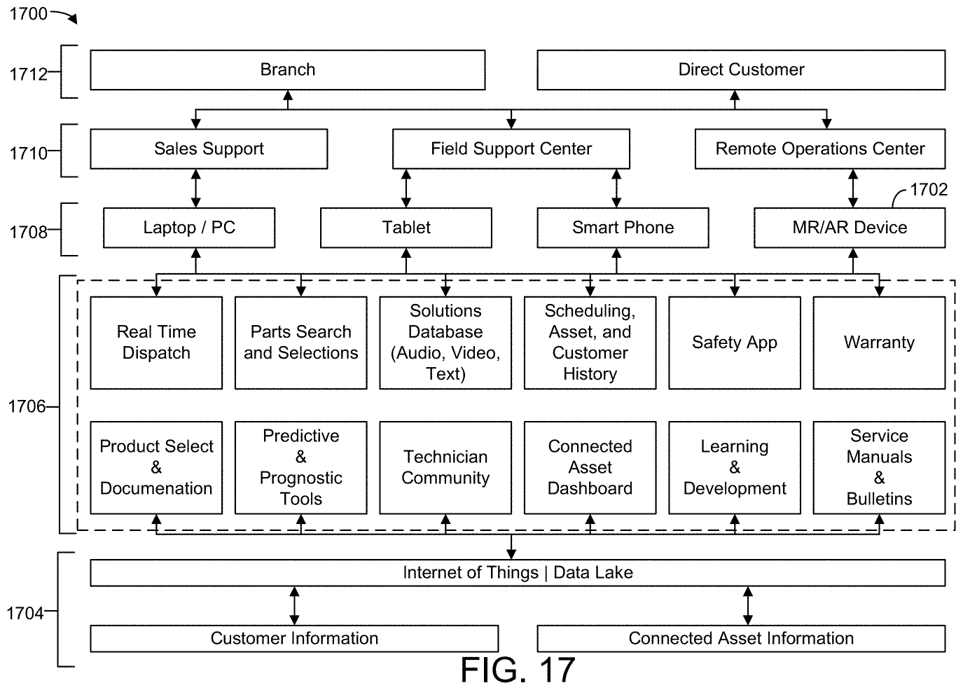

Referring now to FIG. 17, a block diagram of a communication network 1700 including an MR/AR device 1702 is shown. In some embodiments, MR/AR device 1702 is similar to and/or the same as MR device 502 as described with reference to FIGS. 5-13 and/or as AR device 1402 as described with reference to FIGS. 14-16. Communication network 1700 may be configured to provide data to MR/AR device 1702, which may then be communicated to an end user.

In general, communication network 1700 may include five layers. As shown, a layer 1704 may include internet of things (IoT) enabled devices and equipment configured to gather and process data. A layer 1706 may be a connected application/services layer, including tools to extract and analyze data from cloud services and create reporting and diagnostic dashboards. Further, a layer 1708 may be an experiential layer including platforms/devices (e.g., MR device 502, AR device 1402, MR/AR device 1702) configured to simulate and/or augment the analyzed data to provide value-added services for field service, operations, sales, and customers. A layer 1710 may include the consumers of the cloud data and/or generated data. Further, as shown, a layer 1712 may include the beneficiaries of the cloud data and/or generated data.

Still referring to FIG. 17, layer 1704 is shown to include obtaining customer information and connected asset information via IoT connections. Layer 1704 may be in communication with layer 1706. As shown, layer 1706 may include a plurality of tools configured to analyze data from layer 1704. In some embodiments, layer 1706 may include warranty information, service manuals and bulletins, safety applications, learning and development features, scheduling assets and customer history, a connected asset dashboard, technician community features, a solutions database (e.g., including audio, video, text), predictive and prognostic tools, parts search and selections, real time dispatch, and/or production selection and documentation. In some embodiments, layer 1706 may include additional modules and/or functions. Additionally, in some embodiments, layer 1706 may be in communication with layer 1708.

As shown, layer 1708 may include a plurality of devices and/or platforms configured to display and/or augment data from layer 1706. In some embodiments, for example, layer 1708 may include a laptop/PC, a tablet, a smart phone, and/or MR/AR device 1702. In some embodiments, additional devices and/or platforms maybe included in layer 1708. As shown, layer 1708 may be in communication with layer 1710.

In some embodiments, layer 1710 may include sales support, a field support center, and/or a remote operations center. In some embodiments, additional end consumers may be included in layer 1710. Further, layer 1710 may be in communication with layer 1712.

As shown, layer 1712 may include the end beneficiaries of the cloud data and/or generated data. In some embodiments, for example, the end beneficiaries may include direct customers and/or a company branch. As described above, AR device 1402 and/or MR device 502 may be used as sales tools for customers, troubleshooting tools for field service technicians, and/or training tools for new or existing employees. In some embodiments, layer 1712 may include additional end beneficiaries.

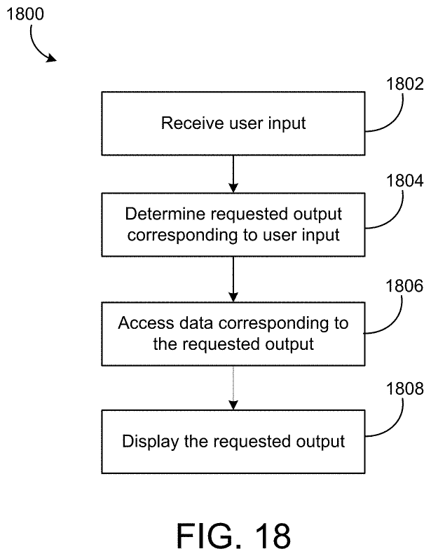

Referring now to FIG. 18, a flowchart of a method 1800 for using an MR/AR device (e.g. MR device 502, AR device 1402, MR device 502, MR/AR device 1702) is shown, according to some embodiments. Method 1800 is shown to include receiving user input (step 1802). As previously described, in some embodiments, the user input may be a vocal input and/or a gesture input. Additional inputs may also be implemented. The user inputs may be captured by a microphone, an optical camera, an inertial measurement unit, and/or any other components of the MR/AR device capable of capturing the user input. In some embodiments, step 1802 is performed by MR device 502 and/or AR device 1402.

Method 1800 is further shown to include determining a requested output corresponding to the user input (step 1804). In some embodiments, the requested output corresponds to real-time and/or historical data, a 2D or 3D device model, and/or a site location. In some embodiments, rather than the user input, the requested output is determined based on a separate determination. For example, the requested output can be based on a determination that the MR/AR device is within a certain proximity of a building device, and as such, a model of the building device and relevant historic/real-time data can be requested. In some embodiments, step 1804 is performed by MR device 502 and/or AR device 1402.

Method 1800 is also shown to include accessing data corresponding to the requested output (step 1806). In some embodiments, step 1806 may include accessing cloud data, accessing data stored remotely (e.g., within a database), and/or communicating with other remote devices. In particular, the data may be stored on a cloud database such that the MR/AR device can provide a request to the cloud database for the data. To access the data, step 1806 may including providing a request for the data. The request can, for example, be provided to the cloud database which can provide the data requested to the MR/AR device. In some embodiments, step 1806 is performed by cloud database 504, MR device 502 and/or AR device 1402.

Method 1800 is shown to include displaying the requested output (step 1808). In some embodiments, displaying output data may include projecting images (e.g., 2D or 3D models, holograms, etc.) on a visual display the MR/AR device. For example, the images can be projected onto an optical projection system of the MR device and/or can be projected to a display screen of the AR device. In some embodiments, displaying output data may include superimposing images over captured images (e.g., superimposing images onto a live video). In some embodiments, step 1808 is performed by MR device 502 and/or AR device 1402. Additional display methods may be implemented.

In some embodiments, method 1800 may be implemented by MR device 502, as described with respect to FIGS. 5-13. Further, in some embodiments, method 1800 may be implemented by AR device 1402, as described with respect to FIGS. 14-16. In some embodiments, method 1800 may be implemented by MR/AR device 1702 as described with reference to FIG. 17.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system for displaying information to a user, the system comprising:
a building management system (BMS) comprising at least one operating device; and
a mixed reality (MR) device comprising:
an optical projection system configured to display images; and
a controller comprising a processing circuit in communication with the optical projection system, the BMS, and a cloud database, the processing circuit configured to:
receive a user input from a component of the MR device;
provide a request for a device model and data describing the at least one operating device to the cloud database, the cloud database storing the device model and the data, the request based on the user input;
receive the device model and the data from the cloud database; and
display, via the optical projection system, a visualization of the device model and the data describing the at least one operating device.

2. The system of claim 1, wherein the data comprise historic data and real-time data of the at least one operating device.

3. The system of claim 1, the processing circuit further configured to:
update the visualization based on a determination that new data describing the at least one operating device is gathered; and
update the visualization based on a detection of a user movement.

4. The system of claim 1, wherein the data describing the at least one operating device is real-time data and the BMS is configured to provide the real-time data describing the at least one operating device to the cloud database.

5. The system of claim 1, wherein the user input comprises at least one of:
a voice command;
a gesture; or
a button press.

6. The system of claim 1, wherein the processing circuit is configured to:
determine if the MR device is within a predetermined proximity of the at least one operating device; and
in response to a determination that the MR device is within the predetermined proximity, automatically provide the request for the device model and the data describing the at least one operating device to the cloud database.

7. The system of claim 1, comprising a plurality of MR devices, wherein each MR device of the plurality of MR devices is configured to communicate with the BMS and the cloud database.

8. A system for displaying information to a user, the system comprising:
a building management system (BMS) comprising at least one operating device; and
an augmented reality (AR) device comprising:
at least one camera configured to capture images relative to the AR device;
a user interface configured to display the images; and
a controller comprising a processing circuit in communication with the at least one camera, the user interface, a cloud database, and the BMS, the processing circuit configured to:
receive a user input via the user interface;
capture at least one image of the at least one operating device;
provide a request for data describing the at least one operating device to the cloud database, the cloud database storing the data, the request based on the user input;
receive the data from the cloud database; and
display, via the user interface, a visualization of the data superimposed on the at least one image.

9. The system of claim 8, wherein the superimposed data provides a visual indication of a fault condition corresponding to the at least one operating device.

10. The system of claim 8, wherein the data describing the at least one operating device is real-time data and the BMS is configured to provide the real-time data describing the at least one operating device to the cloud database.

11. The system of claim 8, wherein the processing circuit is configured to:
update the visualization based on a determination that new data describing the at least one operating device is gathered; and
update the visualization based on a detection of a user movement.

12. The system of claim 8, wherein the processing circuit is configured to:
determine if the AR device is within a certain proximity of the at least one operating device; and
in response to a determination that the AR device is within the certain proximity, automatically provide the request for the data describing the at least one operating device to the cloud database.

13. The system of claim 8, wherein the system comprises a plurality of AR devices, wherein each AR device of the plurality of AR devices is configured to communicate with the BMS and the cloud database.

14. A method for displaying information to a user, the method comprising:
receiving, by a mixed reality (MR) device of the user, a user input corresponding to a user request;
providing, by the MR device, a request for a device model and data describing at least one operating device of a building management system (BMS) to a cloud database, the cloud database storing the device model and the data, the request based on the user input;
receiving, by the MR device, the device model and the data from the cloud database; and
displaying, by the MR device, a visualization of the device model and the data describing the at least one operating device.

15. The method of claim 14, wherein the data comprise historic data and real-time data of the at least one operating device.

16. The method of claim 14, further comprising:
updating, by the MR device, the visualization based on a determination that new data describing the at least one operating device is gathered; and
updating, by the MR device, the visualization based on a detection of a user movement.

17. The method of claim 14, wherein the data describing the at least one operating device is real-time data and the BMS is configured to provide the real-time data describing the at least one operating device to the cloud database.

18. The method of claim 14, wherein the user input comprises at least one of:
a voice command;
a gesture; or
a button press.

19. The method of claim 14, further comprising:
determining, by the MR device, if a user device of the user is within a predetermined proximity of the at least one operating device; and
in response to a determination that the user device of the user is within the predetermined proximity, automatically providing, by the MR device, the request for the device model and the data describing the at least one operating device to the cloud database.

20. The method of claim 14, wherein each of a plurality of MR devices are configured to communicate with the BMS and the cloud database.
